(19) United States
(12) Patent Application Publication
(10) Pub. No.: US 2016/0204569 A1
(43) Pub. Date: Jul. 14, 2016

(54) WAVELENGTH TUNABLE OPTICAL TRANSMITTER

(71) Applicant: Fujitsu Optical Components Limited, Kawasaki-shi (JP)

(72) Inventor: Hiroshi Kuzukami, Kawasaki (JP)

(73) Assignee: Fujitsu Optical Components Limited, Kawasaki (JP)

(21) Appl. No.: 14/947,693

(22) Filed: Nov. 20, 2015

(30) Foreign Application Priority Data
Jan. 9, 2015 (JP) 2015-003555

(51) Int. Cl. H01S 3/102; H01S 3/00; H01S 3/04; H01S 3/106

(52) U.S. Cl. CPC H01S 3/1028; H01S 3/1062; H01S 3/0014; H01S 3/0405

(57) ABSTRACT

An optical transmitter includes: a wavelength tunable light source; an etalon filter that filters output light of the light source; a measurement unit that generates a monitor value corresponding to power of output light of the etalon filter; and a controller that controls a temperature of the light source and a temperature of the etalon filter. Until the wavelength of the output light of the light source is adjusted to a target wavelength, the controller alternately performs first processing to control the temperature of the light source based on the monitor value so as to shift the wavelength of the output light of the light source by a specified amount, and second processing to control the temperature of the etalon filter based on the monitor value so as to shift the transmission characteristics of the etalon filter by the specified amount.

### CROSS-REFERENCE TO RELATED APPLICATIONS

This application is based upon and claims the benefit of priority of the prior Japanese Patent Application No. 2015-003555, filed on Jan. 9, 2015, the entire contents of which are incorporated herein by reference.

### FIELD

The embodiments discussed herein are related to an optical transmitter having a wavelength tuning function.

### BACKGROUND

Recently, higher speeds and larger capacity in a network have been requested. As a countermeasure meeting these requests, WDM (Wavelength Division Multiplexing) has been put to practical use. In conventional WDM, signal channels are arranged at previously specified wavelength spacing. In ITU-T, for example, a wavelength grid of 50 GHz spacing or 100 GHz spacing is proposed.

In an optical transmitter (or an optical transceiver) used in a WDM transmission system, it is requested that an optical signal of a desired wavelength on the wavelength grid can be generated. Therefore, the optical transmitter preferably has a wavelength tuning function.

The wavelength tuning function of the optical transmitter is realized, for example, using a wavelength tunable light source and an etalon filter. A wavelength of output light of the wavelength tunable light source is controlled, for example, by a temperature. The etalon filter has periodical transmission characteristics with respect to wavelength. That is, transmissivity of the etalon filter changes periodically with respect to wavelength. A gap between a pair of mirrors of the etalon filter is appropriately designed, and thereby a desired period (FSR: Free Spectral Range) can be realized. Further, the etalon filter is designed according to a specified wavelength grid. For example, when the wavelength grid of the WDM transmission system is 50 GHz spacing, an etalon filter of FSR=50 GHz is used.

In order to generate an optical signal on the specified wavelength grid, correction data representing a correspondence relationship between operation conditions (e.g., a temperature) of the wavelength tunable light source and an output level of the etalon filter is previously prepared through a measurement, for example, with respect to the wavelength on each grid. For example, for a wavelength grid that accommodates 88 wavelengths (λ1 to λ88), 88 sets of correction data (temperatures T1 to T88 and output levels M1 to M88) are prepared. When an optical signal of the wavelength λ1 is output, the optical transmitter controls a temperature of the wavelength tunable light source to T1, and then adjusts the temperature of the wavelength tunable light source so that the output level of the etalon filter becomes M1. At this time, feedback control is performed in which the temperature of the wavelength tunable light source is adjusted using the output level of the etalon filter. Thereby, an oscillation wavelength of the wavelength tunable light source is controlled to λ1.

A wavelength control method and an optical transmission device capable of controlling wavelengths at arbitrary wavelength spacing using a combination of two cyclic filters (e.g., Japanese Laid-open Patent Publication No. 2011-54714) are proposed. Further, a method is proposed for controlling a wavelength spacing of laser light using an etalon filter (e.g., Japanese Laid-open Patent Publication No. 2012-33895).

Recently, a method has been studied for transmitting a WDM signal using a wavelength grid different from an existing wavelength grid (e.g., 50 GHz grid, 100 GHz grid, etc). To increase communication capability, for example, a wavelength grid (e.g., 37.5 GHz grid) with narrower wavelength spacing is proposed. Under such conditions, an optical transmitter can preferably operate in various wavelength grids.

However, as described above, in order that an optical signal of a wavelength on a specified wavelength grid may be generated, correction data representing a correspondence relationship between operation conditions of the wavelength tunable light source and an output level of the etalon filter is requested to be previously prepared through a measurement with respect to the wavelength grid. Therefore, in order that the optical transmitter may correspond to a plurality of wavelength grids, the correction data is requested to be prepared through the measurement with respect to each of the plurality of wavelength grids. That is, in order that the optical transmitter may correspond to the plurality of wavelength grids, a time requested to perform operations for collecting the correction data for controlling the wavelength tunable light source becomes long. Also, a size of a memory for storing the correction data becomes large.

### SUMMARY

According to an aspect of the embodiments, an optical transmitter includes: a wavelength tunable light source; an etalon filter that filters output light of the wavelength tunable light source; a measurement unit that generates a monitor value corresponding to power of output light of the etalon filter; and a controller that controls a temperature of the wavelength tunable light source to adjust a wavelength of the output light of the wavelength tunable light source, and controls a temperature of the etalon filter to adjust transmission characteristics of the etalon filter. The controller controls the temperature of the wavelength tunable light source to adjust the wavelength of the output light of the wavelength tunable light source to a specified wavelength. During the wavelength of the output light of the wavelength tunable light source is adjusted from the specified wavelength to a target wavelength, the controller alternately performs first processing to control the temperature of the wavelength tunable light source based on the monitor value so as to shift the wavelength of the output light of the wavelength tunable light source by a specified amount, and second processing to control the temperature of the etalon filter based on the monitor value so as to shift the transmission characteristics of the etalon filter by the specified amount.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an optical transmitter according to an embodiment of the present invention.

FIGS. 2A and 2B illustrate transmission characteristics of an etalon filter.

FIG. 3 is a flowchart illustrating a procedure for preparing correction data.

FIG. 4 illustrates an example of initial setting of the etalon filter.

FIG. 5 illustrates an example of the correction data.

FIGS. 6A and 6B illustrate a method for detecting wavelength characteristics and temperature characteristics of the etalon filter.

FIG. 7 is a flowchart illustrating a method for adjusting a wavelength.

FIG. 8 illustrates the correction data used in the embodiment.

FIGS. 9A and 9B illustrate processing of adjusting the wavelength.

FIG. 10 illustrates an example of a hardware configuration of the optical transmitter.

FIG. 11 illustrates an example of an optical transceiver module including the optical transmitter.

FIG. 12 illustrates an example of the optical transmitter according to another embodiment of the present invention.

FIG. 13 is a flowchart illustrating a method for adjusting the wavelength in the optical transmitter illustrated in FIG. 12.

### DESCRIPTION OF EMBODIMENTS

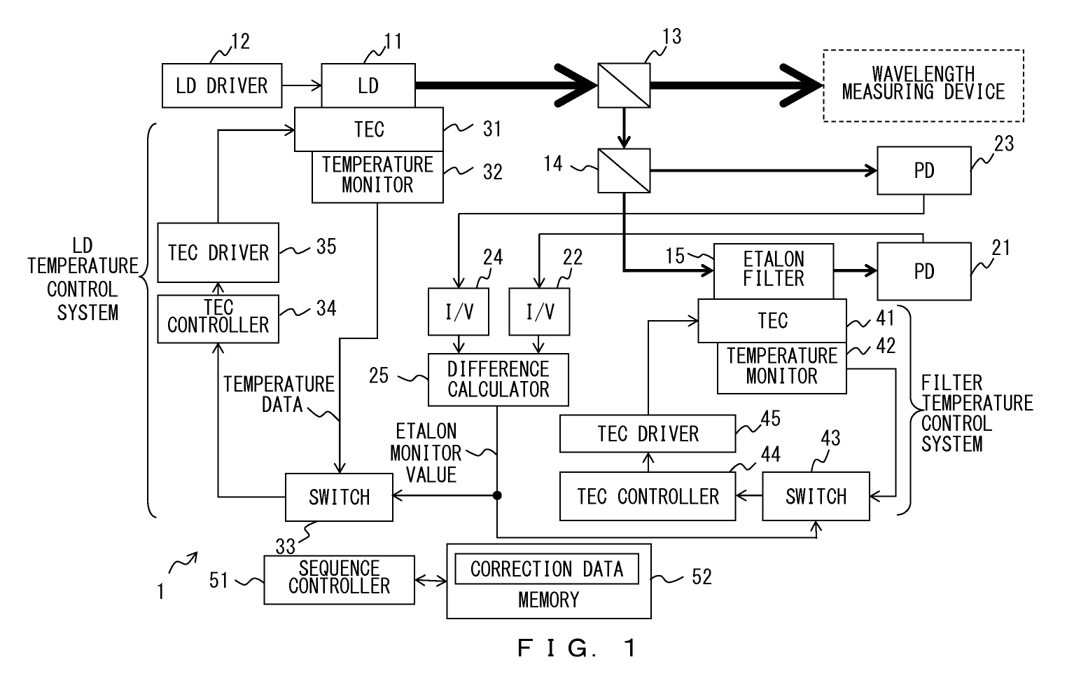

FIG. 1 illustrates an example of an optical transmitter according to an embodiment of the present invention. As illustrated in FIG. 1, the optical transmitter 1 of the embodiment includes a light source (LD) 11, an LD driver 12, optical splitters 13 and 14, and an etalon filter 15. Further, the optical transmitter 1 includes a measurement circuit and a control circuit.

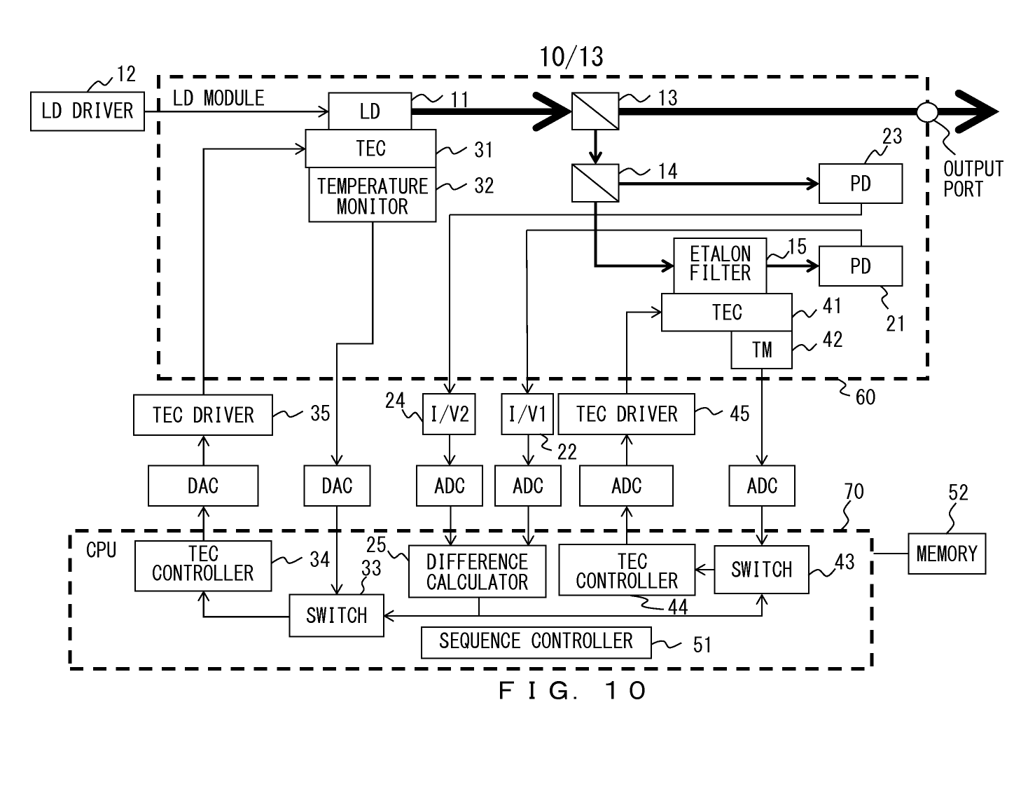

In this example, the light source 11 is a wavelength tunable laser light source. A wavelength of output light of the light source 11 depends on a temperature of the light source 11. That is, the optical transmitter 1 can generate an optical signal of a desired wavelength by controlling a temperature of the light source 11. Power of the output light of the light source 11 is controlled by a current supplied from the LD driver 12. The optical splitter 13 branches the output light of the light source 11 and guides the branched output light to an output port (not illustrated) and the optical splitter 14. Note that an example of the output port is illustrated in FIG. 10. The optical splitter 14 branches the light guided from the optical splitter 13 and guides the branched light to the etalon filter 15 and a photo detector (PD) 23. Therefore, the output light of the light source 11 is guided to the etalon filter 15. The etalon filter 15 has transmission characteristics in which transmissivity changes periodically with respect to wavelength. Further, the etalon filter 15 filters the output light of the light source 11.

The measurement circuit includes a photo detector (PD) 21, a current-to-voltage converter (I/V) 22, the photo detector (PD) 23, a current-to-voltage converter (I/V) 24, and a difference calculator 25. The photo detector 21 generates a current signal representing power of the output light of the etalon filter 15. The current-to-voltage converter 22 converts the current signal output from the photo detector 21 into a voltage signal. Therefore, the voltage signal generated by the current-to-voltage converter 22 represents the power of the output light of the etalon filter 15. The photo detector 23 generates a current signal representing power of the light guided to the photo detector 23 by the optical splitters 13 and 14. Here, when a branching ratio is assumed to be 50:50 in the optical splitter 14, the current signal generated by the photo detector 23 represents power of input light of the etalon filter 15. The current-to-voltage converter 24 converts the current signal output from the photo detector 23 into a voltage signal.

The difference calculator 25 calculates a difference between the voltage signal generated by the current-to-voltage converter 22 and the voltage signal generated by the current-to-voltage converter 24. Here, when the power of the output light of the light source 11 is assumed to be constant, the voltage signal generated by the current-to-voltage converter 24 is also substantially constant. In this case, an operation result according to the difference calculator 25 substantially represents the power of the output light of the etalon filter 15. In the following descriptions, the operation result according to the difference calculator 25 may be referred to as an “etalon monitor value”. However, the etalon monitor value is not limited to the operation result according to the difference calculator 25. That is, values depending on the power of the output light of the etalon filter 15 can be used as the etalon monitor value. For example, an output signal (namely, an electric signal representing the power of the output light of the etalon filter 15) of the photo detector 21 (or the current-to-voltage converter 22) may be used as the etalon monitor value.

The control circuit includes an LD temperature control system, a filter temperature control system, a sequence controller 51, and a memory 52. Further, the control circuit controls a temperature of the light source 11 to adjust a wavelength of the output light of the light source 11. Further, the control circuit controls a temperature of the etalon filter 15 to adjust the transmission characteristics of the etalon filter 15.

The LD temperature control system includes a temperature adjustment device (TEC) 31, a temperature monitor 32, a switch 33, a TEC controller 34, and a TEC driver 35. The temperature adjustment device 31 is implemented in the vicinity of the light source 11, and adjusts a temperature of the light source 11. In this embodiment, the temperature adjustment device 31 is a Thermo-Electric Cooler. The Thermo-Electric Cooler is realized, for example, by a Peltier device. The temperature monitor 32 detects a temperature of the light source 11 and generates temperature data. According to instructions given from the sequence controller 51, the switch 33 selects the temperature data generated by the temperature monitor 32 or the etalon monitor value representing the power of the output light of the etalon filter 15. The temperature data or the etalon monitor value selected by the switch 33 is given to the TEC controller 34 as a feedback signal. The TEC controller 34 generates a temperature control signal based on the feedback signal. The TEC driver 35 drives the temperature adjustment device 31 according to the temperature control signal generated by the TEC controller 34.

The filter temperature control system includes a temperature adjustment device (TEC) 41, a temperature monitor 42, a switch 43, a TEC controller 44, and a TEC driver 45. The temperature adjustment device 41 is implemented in the vicinity of the etalon filter 15, and adjusts the temperature of the etalon filter 15. Like the temperature adjustment device 31, the temperature adjustment device 41 is realized, for example, by the Thermo-Electric Cooler. The temperature monitor 42 detects the temperature of the etalon filter 15 and generates temperature data. According to the instructions given from the sequence controller 51, the switch 43 selects the temperature data generated by the temperature monitor 42 or the etalon monitor value representing the power of the output light of the etalon filter 15. The temperature data or the etalon monitor value selected by the switch 43 is given to the TEC controller 44 as the feedback signal. The TEC controller 44 generates the temperature control signal based on the feedback signal. The TEC driver 45 drives the temperature adjustment device 41 according to the temperature control signal generated by the TEC controller 44.

The sequence controller 51 adjusts a wavelength of the output light of the light source 11 using the LD temperature control system. At this time, the sequence controller 51 can operate the LD temperature control system in an ATC (Auto Temperature Control) mode or an AFC (Auto Frequency Control) mode.

In the ATC mode, a temperature of the light source 11 is adjusted to a target temperature. In this case, for example, the sequence controller 51 gives an instruction value representing the target temperature to the TEC controller 34. According to the instruction from the sequence controller 51, the switch 33 selects the temperature data generated by the temperature monitor 32. Further, the TEC controller 34 controls a temperature of the light source 11 so that the temperature data approaches the instruction value. As a result, the light source 11 is adjusted to the target temperature and the light source 11 outputs light of a wavelength corresponding to the temperature of the light source 11.

In the AFC mode, a wavelength (namely, a frequency) of the output light of the light source 11 is adjusted to the target wavelength. In this case, for example, the sequence controller 51 gives an instruction value representing the etalon monitor value corresponding to the target wavelength to the TEC controller 34. According to the instruction value from the sequence controller 51, the switch 33 selects the etalon monitor value. Further, the TEC controller 34 controls a temperature of the light source 11 so that the etalon monitor value approaches the instruction value. As a result, the wavelength of the output light of the light source 11 is adjusted to the target wavelength.

Similarly, the sequence controller 51 adjusts transmission characteristics of the etalon filter 15 using the filter temperature control system. At this time, the sequence controller 51 can operate the filter temperature control system in the ATC mode or the AFC mode.

In the ATC mode, the temperature of the etalon filter 15 is adjusted to the target temperature. In this case, for example, the sequence controller 51 gives an instruction value representing the target temperature to the TEC controller 44. According to the instruction value from the sequence controller 51, the switch 43 selects the temperature data generated by the temperature monitor 42. Then, the TEC controller 44 controls the temperature of the etalon filter 15 so that the temperature data approaches the instruction value. As a result, the temperature of the etalon filter 15 is adjusted to the target temperature. The transmission characteristics of the etalon filter 15 depend on the temperature of the etalon filter 15.

In the AFC mode, the transmission characteristics of the etalon filter 15 with respect to the wavelength are adjusted to the target characteristics. In this case, for example, the sequence controller 51 gives an instruction value representing the target characteristics to the TEC controller 44. According to the instruction value from the sequence controller 51, the switch 43 selects the etalon monitor value. Then, the TEC controller 44 controls the temperature of the etalon filter 15 so that the etalon monitor value approaches the instruction value. As a result, the transmission characteristics of the etalon filter 15 with respect to the wavelength are adjusted to the target characteristics.

In the memory 52, correction data is stored. The correction data will be described in detail below. The memory 52 is realized, for example, by a semiconductor device. Note that other data may be stored in the memory 52.

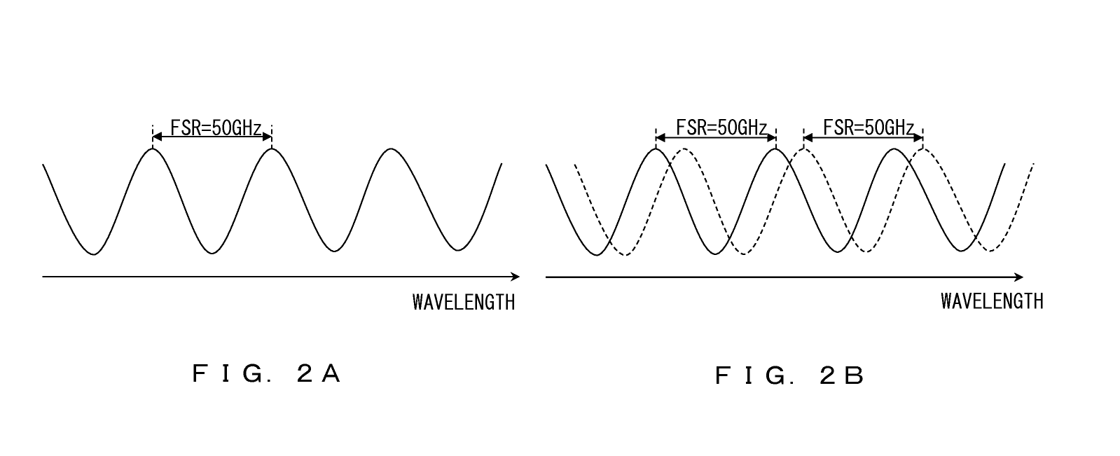

FIGS. 2A and 2B illustrate the transmission characteristics of the etalon filter 15. As illustrated in FIG. 2A, transmissivity of the etalon filter 15 changes periodically with respect to the wavelength. A period of a change in the transmissivity of the etalon filter 15 is represented by an FSR. In an example illustrated in FIG. 2A, the etalon filter 15 is designed so that FSR=50 GHz is obtained. The FSR of the etalon filter 15 depends on a gap between a pair of mirrors configuring the etalon filter 15.

The transmission characteristics of the etalon filter 15 depend on a temperature. When the temperature of the etalon filter 15 changes, a transmissivity curve is shifted to the long wavelength side or the short wavelength side on a wavelength axis. Specifically, when the temperature of the etalon filter 15 changes, the transmissivity curve of the etalon filter 15 is shifted from a condition illustrated by a solid line to a condition illustrated by a broken line, for example, as illustrated in FIG. 2B. However, even if the temperature of the etalon filter 15 changes, the FSR does not change.

A wavelength of the output light of the light source 11 is adjusted using the etalon filter 15. However, the wavelength is adjusted using the correction data previously prepared. Therefore, a procedure of preparing the correction data will be described.

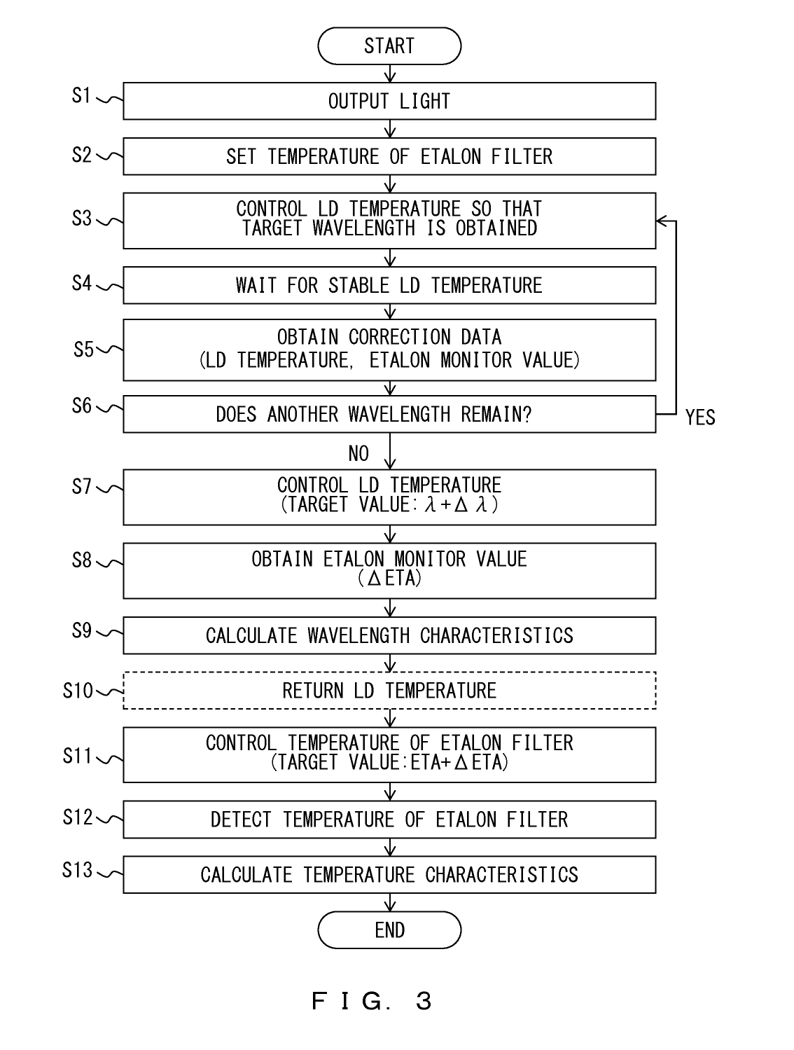

FIG. 3 is a flowchart illustrating the procedure of preparing the correction data. The correction data is prepared for a certain specified wavelength grid. The correction data is prepared, for example, for the wavelength grid of 50 GHz spacing proposed by ITU-T. In this case, the FSR of the etalon filter 15 is 50 GHz.

The correction data may be manually prepared by a manufacturer of the optical transmitter 1. However, this procedure may be performed by the sequence controller 51.

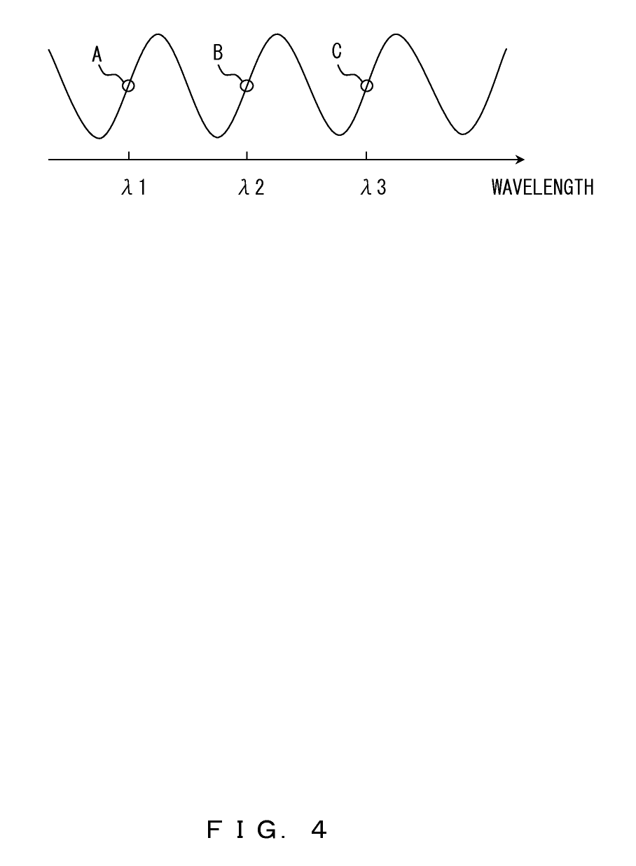

In S1, the light source 11 is driven by the LD driver 12. Specifically, light is output from the light source 11. When the correction data is prepared, the power of the output light of the light source 11 is assumed to be constant. In S2, the temperature of the etalon filter 15 is controlled by the TEC controller 44. At this time, as illustrated in FIG. 4, the temperature of the etalon filter 15 is controlled so that areas in which a tilt of the transmissivity of the etalon filter 15 is large coincide with respective wavelengths λ1, λ2, λ3, . . . on the wavelength grids of the WDM. Specifically, the temperature of the etalon filter 15 is controlled so that a point A, a point B, a point C . . . illustrated in FIG. 4 coincide with the wavelengths λ1, λ2, λ3, . . . , respectively.

In S3-S4, the temperature of the light source 11 is controlled so that the wavelength of the output light of the light source 11 becomes the target wavelength. The target wavelength is one wavelength on the specified wavelength grid. The temperature of the light source 11 is controlled, for example, so that the wavelength of the output light of the light source 11 becomes the wavelength λ1 illustrated in FIG. 4. At this time, the wavelength of the output light of the light source 11 is measured using a wavelength measuring device illustrated in FIG. 1.

In S5, the correction data corresponding to the target wavelength is detected. Specifically, when the wavelength of the output light of the light source 11 coincides with the target wavelength, the temperature of the etalon filter 15, the temperature of the light source 11, and the etalon monitor value are detected. The temperature of the etalon filter 15 is detected by the temperature monitor 42. The temperature of the light source 11 is detected by the temperature monitor 32. The etalon monitor value is calculated by the difference calculator 25. Then, the detected correction data is stored in the memory 52.

The temperature of the etalon filter 15 is substantially kept constant while a process of preparing the correction data is performed. Accordingly, in S5, the temperature of the etalon filter 15 need not necessarily be detected.

In S6, it is decided whether or not the wavelength for which the correction data is not obtained remains. When the wavelength for which the correction data is not obtained remains, the next target wavelength is selected and the process of preparing the correction data returns to S3. That is, processes of S3-S5 are repeatedly performed, and thereby the correction data is obtained about all the target wavelengths.

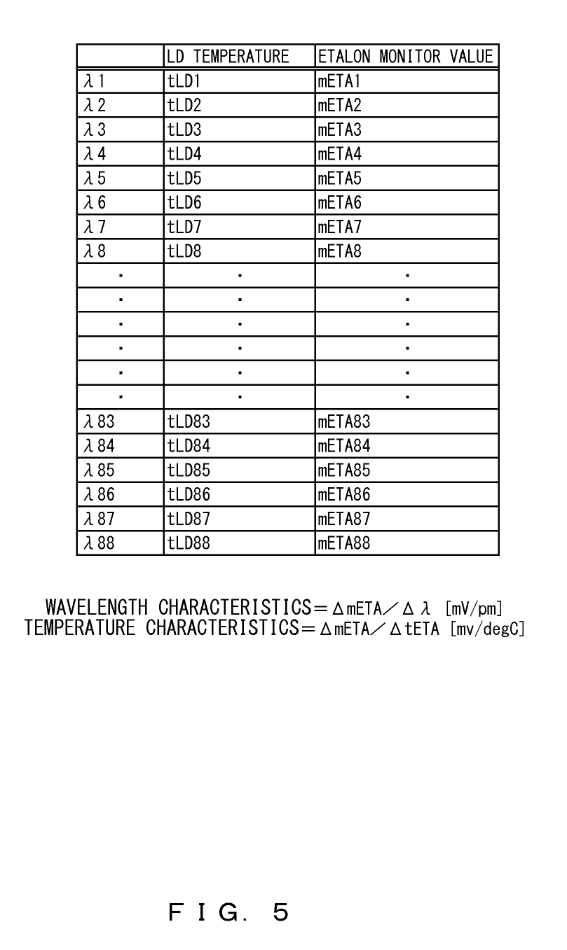

FIG. 5 illustrates an example of the collected correction data. In this example, the correction data is collected with respect to the wavelengths λ1 to λ88. The wavelengths λ1 to λ88 correspond to wavelengths on the specified wavelength grid. Temperatures tLD1 to tLD88 represent the temperature of the light source 11 for obtaining the wavelengths λ1 to λ88, respectively. Etalon monitor values mETA1 to mETA88 represent the etalon monitor values obtained at the time when the wavelengths of the output light of the light source 11 are the wavelengths λ1 to λ88, respectively.

In S7-S9, the wavelength characteristics of the etalon filter 15 are detected. Specifically, in S7, the temperature of the light source 11 is controlled, and thereby the wavelength of the output light of the light source 11 is shifted by Δλ. Further, in S8, a change ΔETA in the etalon monitor value corresponding to the wavelength shift of S7 is detected. Then, in S9, a ratio of Δλ and ΔETA is calculated, and thereby the wavelength characteristics (ΔETA/Δλ) of the etalon filter 15 are calculated.

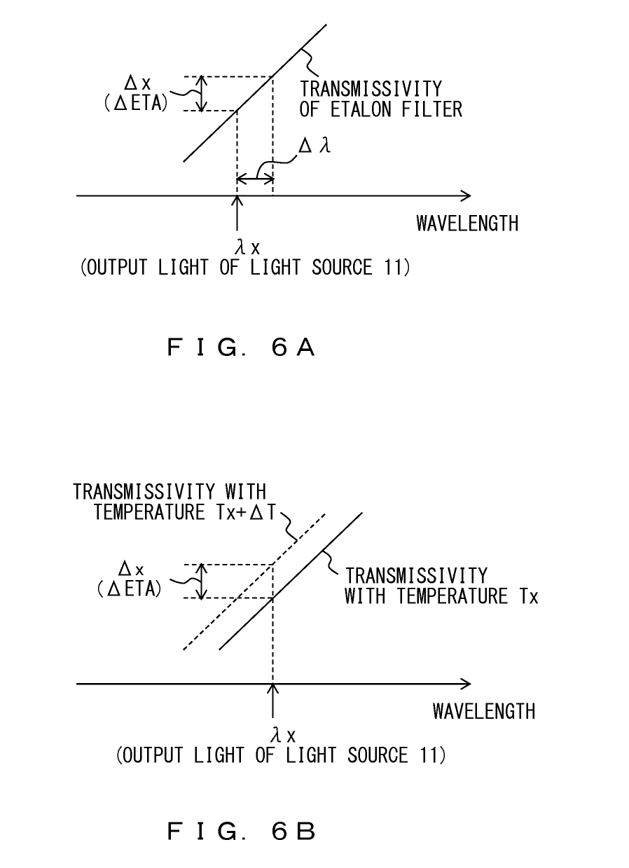

FIG. 6A illustrates a method for detecting the wavelength characteristics of the etalon filter 15. When the wavelength characteristics of the etalon filter 15 are detected, the temperature of the etalon filter 15 is kept constant and the transmission characteristics of the etalon filter 15 are fixed. Then, in S7, the wavelength of the output light of the light source 11 is shifted from “λx” to “λx+Δλ”. In response to this wavelength shift, the power of the output light of the etalon filter 15 changes by Δx. As a result, the etalon monitor value changes by ΔETA.

In the initial state, for example, the wavelength of the output light of the light source 11 is assumed to be 1533.00 nm and the etalon monitor value generated by the difference calculator 25 is assumed to be 1000 mV. Further, when the temperature of the light source 11 is controlled so that the wavelength of the output light of the light source 11 changes from 1533.00 nm to 1533.01 nm, the etalon monitor value generated with λ=1533.01 nm is assumed to be 1090 mV. In this case, since Δλ=10 pm and ΔETA=90 mV hold, the wavelength characteristics=9 mV/pm is obtained. Thus, the wavelength characteristics of the etalon filter 15 represent a change amount of the etalon monitor value with respect to a change in the wavelength of the output light of the light source 11. In other words, the wavelength characteristics represent a tilt of the etalon monitor value with respect to the wavelength.

In S10, the temperature of the light source 11 is returned to a state before the processes of S7-S9 are performed. However, when a wavelength shift of S7 is small, a change in the temperature of the light source 11 is also small, and therefore S10 may be saved.

In S11-S13, temperature characteristics of the etalon filter 15 are detected. Specifically, in S11, the temperature of the etalon filter 15 is controlled, and thereby the etalon monitor value is shifted by ΔETA. For example, this ΔETA is the same as a value detected in S8. Further, in S12, the temperature change AT corresponding to a shift of the etalon monitor value in S11 is detected. Then, in S13, a ratio of ΔETA and ΔT is calculated, and thereby the temperature characteristics (ΔETA/AT) of the etalon filter 15 are calculated.

FIG. 6B illustrates a method for detecting the temperature characteristics of the etalon filter 15. When the temperature characteristics of the etalon filter 15 are detected, the temperature of the light source 11 is kept constant and the wavelength of the output light of the light source 11 is fixed. Then, in S11, the temperature of the etalon filter 15 is controlled so that the etalon monitor value changes by ΔETA. When the temperature of the etalon filter 15 changes, the transmission characteristics of the etalon filter 15 change according to the above temperature change. In an example illustrated in FIG. 6B, when the temperature of the etalon filter 15 changes from “Tx” to “Tx+ΔT”, a position of the transmissivity curve of the etalon filter 15 is shifted to the short wavelength side and the etalon monitor value changes by ΔETA.

In the initial state, for example, the temperature of the etalon filter 15 is assumed to be 20 degrees and the etalon monitor value is assumed to be 1090 mV. Further, the temperature of the etalon filter 15 is controlled, and thereby, when the etalon monitor value is changed from 1090 mV to 1000 mV, a temperature at which the etalon monitor value=1000 mV is obtained is assumed to be 30 degrees. In this case, since ΔETA=90 mV and ΔT=10 degrees hold, the temperature characteristics=9 mV/degrees is obtained. Thus, the temperature characteristics of the etalon filter 15 represent the change amount of the etalon monitor value with respect to the temperature change of the etalon filter 15. In other words, the temperature characteristics represent a tilt of the etalon monitor value with respect to the temperature.

Wavelength characteristic data and temperature characteristic data of the etalon filter 15 as calculated above are stored in the memory 52. The correction data, the wavelength characteristic data, and the temperature characteristic data stored in the memory 52 are used by the sequence controller 51 at the time of adjusting the wavelength of the output light of the light source 11.

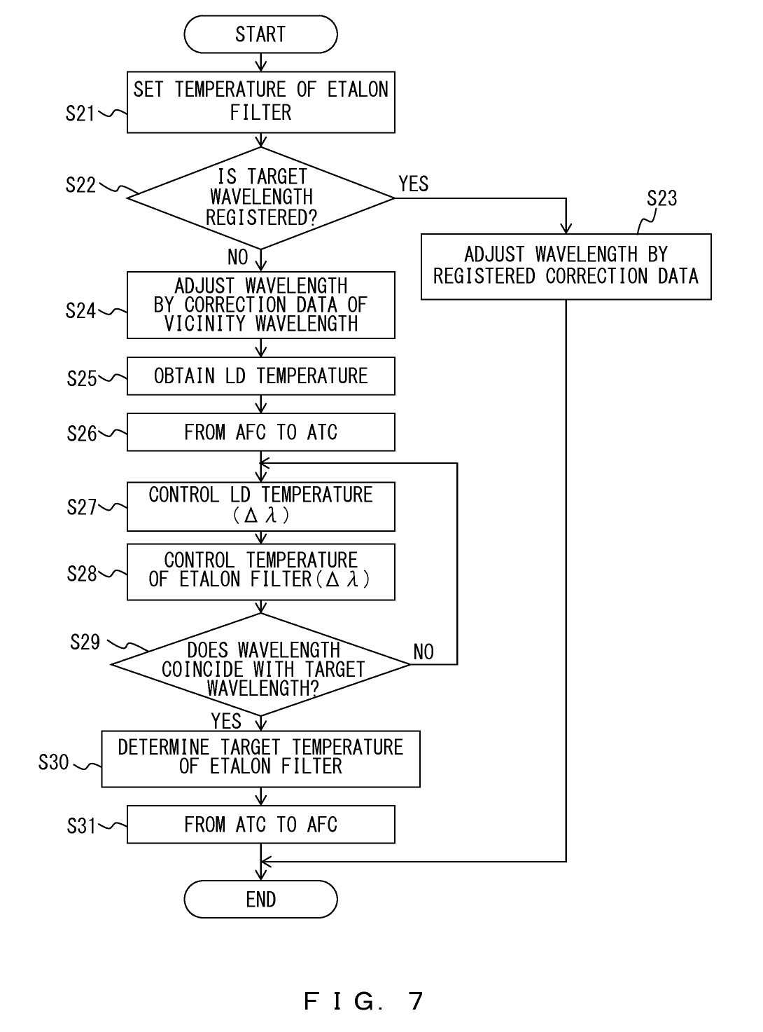

FIG. 7 is a flowchart illustrating a method for adjusting the wavelength of the output light of the light source 11. Processing of this flowchart is performed by the sequence controller 51 when the target wavelength is given to the optical transmitter 1.

In S21, the sequence controller 51 gives an instruction to the TEC controller 44 and controls the temperature of the etalon filter 15. At this time, the sequence controller 51 controls the etalon filter 52 to the same temperature as that at the time of preparing the correction data stored in the memory 52. As a result, the etalon filter 15 is controlled to the same state as that at the time when the correction data is collected. That is, the areas in which a tilt of the transmissivity of the etalon filter 15 is large coincide with the respective wavelengths λ1, λ2, λ3, . . . on the wavelength grids of the WDM.

In S22, the sequence controller 51 decides whether or not the correction data corresponding to the given target wavelength is registered in the memory 52. In S23, when the correction data corresponding to the given target wavelength is registered in the memory 52, the sequence controller 51 adjusts the wavelength of the output light of the light source 11 based on the correction data (target LD temperature data and target etalon monitor value) corresponding to the given target wavelength. Specifically, the sequence controller 51 gives the target LD temperature data to the TEC controller 34. Further, the sequence controller 51 operates the LD temperature control system in the ATC mode. In the ATC mode, the temperature of the light source 11 is controlled so that the temperature data representing the temperature of the light source 11 approaches the target LD temperature data. As a result, the wavelength of the output light of the light source 11 is approximately adjusted to the target wavelength. Subsequently, the sequence controller 51 operates the LD temperature control system in the AFC mode. In the AFC mode, the temperature of the light source 11 is controlled so that the etalon monitor value output from the difference calculator 25 approaches the target etalon monitor value. As a result, the wavelength of the output light of the light source 11 is held at the target wavelength.

In S24, when the correction data corresponding to the given target wavelength is not registered in the memory 52, the sequence controller 51 selects a wavelength most approximated to the target wavelength among the wavelengths for which the correction data is registered in the memory 52. In the following descriptions, the selected wavelength may be referred to as a “vicinity wavelength”. Further, the sequence controller 51 adjusts the wavelength of the output light of the light source 11 based on the correction data corresponding to the vicinity wavelength. As a result, the wavelength of the output light of the light source 11 is held at the vicinity wavelength.

In S25, the sequence controller 51 obtains a current temperature (namely, a temperature of the light source 11 at the time when the wavelength of the output light of the light source 11 is held at the vicinity wavelength) of the light source 11. This temperature is detected by the temperature monitor 32. In S26, the sequence controller 51 switches the operation mode of the LD temperature control system from the AFC mode to the ATC mode. Then, the LD temperature control system controls the temperature of the light source 11 so as to maintain the temperature obtained in S25. That is, the wavelength of the output light of the light source 11 is held at the vicinity wavelength. Further, the sequence controller 51 switches the operation mode of the filter temperature control system from the ATC mode to the AFC mode.

In S27, the sequence controller 51 controls the temperature of the light source 11 so that the wavelength of the output light of the light source 11 is shifted by a specified amount. In the following descriptions, a wavelength amount to be shifted may be referred to as Δλ. At this time, based on the wavelength characteristic data previously calculated, the sequence controller 51 determines the change amount of the etalon monitor value corresponding to Δλ. In the following descriptions, the change amount of the etalon monitor value corresponding to Δλ may be referred to as ΔETA. Then, the sequence controller 51 shifts the target etalon monitor value used in the LD temperature control system by ΔETA. By doing this, the temperature of the light source 11 is controlled so that the detected etalon monitor value approaches the shifted target etalon monitor value. As a result, the wavelength of the output light of the light source 11 is shifted by Δλ. Then, the temperature of the light source 11 is fixed.

In S28, the sequence controller 51 controls the temperature of the etalon filter 51 so that the etalon monitor value is returned to a state before the operation of S27. Specifically, the sequence controller 51 controls the temperature of the etalon filter 15 so that the etalon monitor value is shifted by ΔETA in the reverse direction with respect to S27. Note that, when the temperature of the etalon filter 15 is controlled so that the etalon monitor value is returned to a state before the operation of S27, the transmissivity curve of the etalon filter 15 is shifted by Δλ as illustrated with reference to FIG. 6B.

In S29, the sequence controller 51 decides whether or not the wavelength of the output light of the light source 11 coincides with the target wavelength. The “coincidence” is not limited to a completely coincident state, and includes a state in which an error between the target wavelength and the wavelength of the output light of the light source 11 is sufficiently small. When the wavelength of the output light of the light source 11 does not coincide with the target wavelength, the process of the sequence controller 51 returns to S27. That is, until the wavelength of the output light of the light source 11 coincides with the target wavelength, the processes of S27 and S28 are repeatedly performed. Then, when the wavelength of the output light of the light source 11 coincides with the target wavelength, the process of the sequence controller 51 proceeds to S30.

In S30, the sequence controller 51 fixes the temperature of the etalon filter 15. That is, the transmission characteristics of the etalon filter 15 are fixed. Then, in S31, the sequence controller 51 switches the operation mode of the LD temperature control system from the ATC mode to the AFC mode. Subsequently, the LD temperature control system controls the temperature of the light source 11 so that the etalon monitor value is held at the target value. As a result, the wavelength of the output light of the light source 11 is maintained at the target wavelength.

The process of the flowchart illustrated in FIG. 7 is one embodiment and the present embodiment is not limited thereto. In the above-described embodiment, for example, in S27, the target etalon monitor value used in the LD temperature control system is shifted by ΔETA, and as a result the transmissivity curve of the etalon filter 15 is shifted by Δλ. On the other hand, the target temperature used in the filter temperature control system is shifted, and thereby the transmissivity curve of the etalon filter 15 may be shifted by Δλ. In this case, based on the temperature characteristic data previously calculated, the sequence controller 51 determines the temperature change amount ΔT corresponding to ΔETA. Then, the sequence controller 51 shifts the target temperature used in the filter temperature control system by ΔT. By doing this, the transmissivity curve of the etalon filter 15 is shifted by Δλ according to the feedback control in the filter temperature control system.

As described above, in the optical transmitter 1 of the embodiment, when the correction data corresponding to the given target wavelength is not registered in the memory 52, the processes of S27 and S28 are repeatedly performed until the wavelength of the output light of the light source 11 coincides with the target wavelength. Here, the processes of S27 and S28 are repeatedly performed, and thereby an optical signal of the target wavelength can be generated from the correction data previously generated with respect to the specified wavelength (in the above-described embodiment, the vicinity wavelength) different from the target wavelength. At this time, the etalon filter 15 is controlled to a state of monitoring such that the wavelength of the output light of the light source 11 is adjusted to the target wavelength.

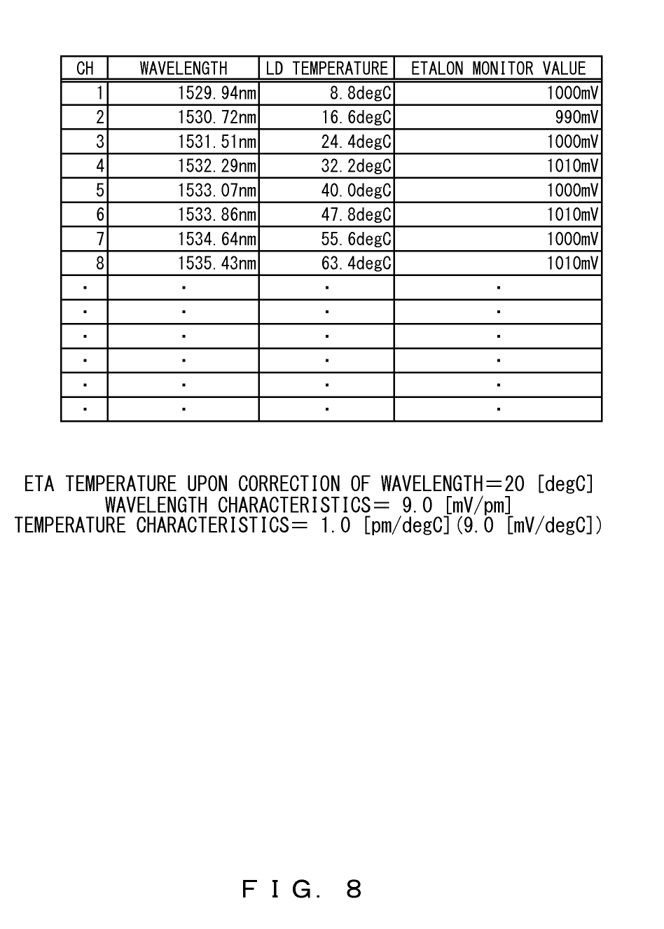

Next, an example of a method for generating an optical signal of the target wavelength will be described. In the following embodiment, the correction data illustrated in FIG. 8 is assumed to have been previously prepared and stored in the memory 52 of the optical transmitter 1. The correction data includes the LD temperature data and the etalon monitor value measured with respect to the respective wavelengths on the specified wavelength grids. Further, the correction data is assumed to be obtained in a state in which the etalon filter 15 is fixed to 20 degrees. According to S7-S13 of the flowchart illustrated in FIG. 3, the wavelength characteristic data (9 mV/pm) and the temperature characteristic data (9 mV/degree (1 pm/degrree)) are calculated and stored in the memory 52.

An instruction to generate an optical signal of the target wavelength 1533.04 nm is given to the optical transmitter 1. However, the correction data corresponding to this target wavelength is not stored in the memory 52. Therefore, the sequence controller 51 selects a wavelength most approximated to the target wavelength among the wavelengths for which the correction data is registered in the memory 52. In this example, a channel CH5 (λ5=1533.07 nm) is selected as illustrated in FIG. 8. Then, the sequence controller 51 controls an operation state of the light source 11 according to the correction data of the channel CH5. Specifically, the sequence controller 51 sets the operation mode of the LD temperature control system to the ATC mode, and controls the temperature of the light source 11 to 40 degrees. Note that the etalon filter 15 is controlled to the temperature (namely, 20 degrees) at the time when the correction data is collected.

When the above-described setting is completed, the LD temperature control system controls the temperature of the light source 11 so as to satisfy the correction data corresponding to the channel CH5. Specifically, the LD temperature control system controls the temperature of the light source 11 so as to obtain the etalon monitor value=1000 mV. As a result, the wavelength of the output light of the light source 11 is maintained at 1533.07 nm. In the following descriptions, this state may be referred to as the “initial state”.

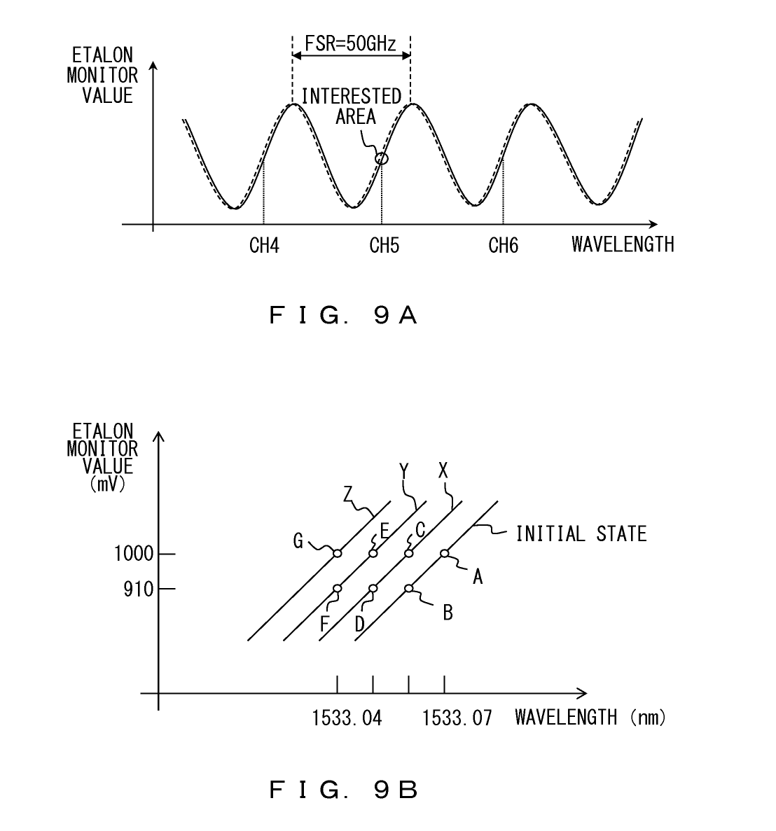

FIG. 9A illustrates an example of a change in the etalon monitor value with respect to the wavelength of the light source 11. As illustrated in FIG. 1, the etalon monitor value represents a difference between input optical power of the etalon filter 15 and output optical power of the etalon filter 15. Here, the input optical power of the etalon filter 15 is assumed to be kept constant without depending on the wavelength. On the other hand, the transmissivity of the etalon filter 15 changes periodically with respect to the wavelength as illustrated in FIG. 2A. Therefore, the etalon monitor value changes periodically with respect to the wavelength similar to the transmissivity of the etalon filter 15. The period of a change in the etalon monitor value is the same as that of a change in the transmissivity of the etalon filter 15, and corresponds to the FSR of the etalon filter 15.

A curve illustrated by a solid line in FIG. 9A indicates a change in the etalon monitor value in the initial state (in this example, a state in which the wavelength of the output light of the light source 11 is maintained at 1533.07 nm). In the initial state, the etalon filter 15 is controlled so that the areas in which a tilt of the transmissivity is large coincide with the respective wavelengths λ1, λ2, λ3, . . . on the wavelength grids of the WDM. Therefore, in the vicinity of the wavelength of each channel in which the correction data is collected, the tilt of the etalon monitor value is large. Note that, in the wavelength areas in which the tilt of the etalon monitor value is large, the etalon monitor value changes approximately linearly with respect to the wavelength.

A curve illustrated by a broken line indicates a change in the etalon monitor value at the time when the temperature of the etalon filter 15 changes in the initial state. As described above, when the temperature of the etalon filter 15 changes, a shape of the curve representing the etalon monitor value does not substantially change; however, a position of the curve representing the etalon monitor value is shifted to the long wavelength side or the short wavelength side. In this example, when the temperature of the etalon filter 15 is lowered, the curve representing the etalon monitor value is shifted to the short wavelength side.

The sequence controller 51 performs processes of S24-S31 illustrated in FIG. 7. In this embodiment, the wavelength shift of S27 is 10 pm.

The sequence controller 51 performs the process of S27 in FIG. 7. That is, the sequence controller 51 controls the temperature of the light source 11 so that the wavelength of the output light of the light source 11 is shifted to the short wavelength side by 10 pm. At this time, based on the wavelength characteristic data, the sequence controller 51 determines the change amount of the etalon monitor value corresponding to the wavelength shift Δλ=10 pm. In this example, the wavelength characteristics=9.0 mV/pm is obtained. Accordingly, ΔETA=90 mV is calculated with respect to the wavelength shift Δλ=10 pm.

By doing this, the sequence controller 51 decreases the target etalon monitor value used in the LD temperature control system by 90 mV. Specifically, the target etalon monitor value is shifted from 1000 mV to 910 mV. In this case, the LD temperature control system controls the temperature of the light source 11 so that the detected etalon monitor value approaches 910 mV. As a result, the wavelength of the output light of the light source 11 is shifted to the short wavelength side by 10 pm. That is, the wavelength of the output light of the light source 11 is adjusted to 1533.06 nm.

Then, the sequence controller 51 performs the process of S28 in FIG. 7. That is, the sequence controller 51 controls the temperature of the etalon filter 15 while the temperature of the light source 11 is fixed. That is, the transmission characteristics of the etalon filter 15 are controlled while the wavelength of the output light of the light source 11 is fixed. Specifically, the sequence controller 51 controls the temperature of the etalon filter 15 so as to compensate for a change in the etalon monitor value due to the wavelength shift of the output light of the light source 11. In this embodiment, due to the wavelength shift of the output light of the light source 11, the etalon monitor value changes from 1000 mV to 910 mV. Therefore, the sequence controller 51 controls the temperature of the etalon filter 15 so that the etalon monitor value is returned from 910 mV to 1000 mV.

At this time, for example, the sequence controller 51 sets the target etalon monitor value used in the filter temperature control system to 1000 mV. In this case, the filter temperature control system controls the temperature of the etalon filter 15 so that the detected etalon monitor value approaches 1000 mV. By doing this, the temperature of the etalon filter 15 is controlled so that the etalon monitor value becomes 1000 mV at the time when the input wavelength of the etalon filter 15 is 1533.06 nm.

Note that the temperature characteristic data representing the temperature characteristics of the etalon filter 15 is stored in the memory 52. Accordingly, a temperature change corresponding to a change in the etalon monitor value due to the wavelength shift of the output light of the light source 11 can be calculated with reference to this temperature characteristic data. In this example, the temperature characteristic data “9 mV/degree” is obtained. Specifically, when the temperature of the etalon filter 15 is lowered by 10 degrees, the etalon monitor value is expected to change from 910 mV to 1000 mV. Therefore, the sequence controller 51 may control the etalon monitor value from 910 mV to 1000 mV by lowering the temperature of the etalon filter 15 by 10 degrees.

When the processes of S27 and S28 are performed as described above, the wavelength of the output light of the light source 11 is adjusted from 1533.07 nm to 153306 nm. Further, the transmission characteristics of the etalon filter 15 are controlled so that the etalon monitor value becomes 1000 mV with respect to the adjusted wavelength (namely, 1533.06 nm).

In this embodiment, the target wavelength is 1533.04 nm. Accordingly, the sequence controller 51 repeatedly performs the processes of S27 and S28 three times. As a result, the wavelength of the output light of the light source 11 is adjusted to 1533.04 nm. Based on a difference between the wavelength in the initial state and the target wavelength, the sequence controller 51 can determine the number of times in which the processes of S27 and S28 are performed.

FIG. 9B schematically illustrates a process of adjusting the wavelength of the output light of the light source 11. FIG. 9B illustrates the interested area illustrated in FIG. 9A.

In the initial state of the wavelength adjustment, the wavelength of the output light of the light source 11 is 1533.07 nm and the etalon monitor value is 1000 mV. Accordingly, the initial state before the wavelength adjustment is performed is represented by a point A illustrated in FIG. 9B.

When the process of S27 is performed, the wavelength of the output light of the light source 11 is adjusted from 1533.07 nm to 1533.06 nm. Specifically, the state of the optical transmitter 1 transits from the point A to a point B. In the point B, the etalon monitor value is 910 mV.

In S28, the temperature of the etalon filter 15 is controlled so as to compensate for a change in the etalon monitor value due to the wavelength shift of S27. Thereby, the transmission characteristics of the etalon filter 15 transit from the initial state to a state X. On the other hand, the wavelength of the output light of the light source 11 does not change. Accordingly, the state of the optical transmitter 1 transits from the point B to a point C. In the point C, the etalon monitor value is returned to the initial state (namely, 1000 mV).

Subsequently, second adjustment processing is performed. By doing this, the state of the optical transmitter 1 transits from the point C to a point E via a point D. In this process, the wavelength of the output light of the light source 11 is adjusted from 1533.06 nm to 1533.05 nm. In addition, the transmission characteristics of the etalon filter 15 transit from the state X to a state Y. In the point E, the etalon monitor value is returned to the initial state (namely, 1000 mV).

Further, third adjustment processing is performed. By doing this, the state of the optical transmitter 1 transits from the point E to a point G via a point F. In this process, the wavelength of the output light of the light source 11 is adjusted from 1533.05 nm to 1533.04 nm. The transmission characteristics of the etalon filter 15 transit from the state Y to a state Z. In the point G, the etalon monitor value is returned to the initial state (namely, 1000 mV).

Subsequently, the optical transmitter 1 controls the temperature of the light source 11 so that the detected etalon monitor value is maintained at 1000 mV. Here, in the above-described wavelength adjustment, the etalon filter 15 is adjusted so that a voltage 1000 mV is obtained with the wavelength 1533.04 nm. Accordingly, the wavelength of the output light of the optical transmitter 1 is maintained at the target wavelength 1533.04 nm.

In the optical transmitter 1, a small wavelength shift (in the above-described example, 10 pm) is repeated, and thereby the wavelength of the output light of the light source 11 gradually approaches the target wavelength; however, the present embodiment is not limited to this method. That is, the processes of S27 and S28 may be performed only once, and thereby the target wavelength may be obtained. In the above-described embodiment, when the wavelength shift amount of S27 is 30 pm, the processes of S27 and S28 are performed only once, and thereby the target wavelength is obtained.

However, when the wavelength shift amount is large, the wavelength of the output light of the light source 11 may be arranged in the area in which a tilt of the transmissivity of the etalon filter 15 is small. When the wavelength of the output light of the light source 11 is arranged in the area in which the tilt of the transmissivity of the etalon filter 15 is small, sensitivity of the etalon monitor value deteriorates with respect to a wavelength fluctuation. That is, there is the possibility that accuracy of the wavelength adjustment will be lowered. Accordingly, it is preferable that the wavelength shift amount of one time in the wavelength adjustment be sufficiently small.

As described above, the optical transmitter 1 of the embodiment can generate an optical signal of not only the wavelength in which the correction data is prepared in advance but also the wavelength in which the correction data is not prepared. In the above-described example, the optical signal of a desired wavelength can be generated based on the correction data corresponding to a certain wavelength grid.

On the other hand, in order to realize the optical transmitter applicable to a plurality of wavelength grids in the prior art, the correction data illustrated in FIG. 5 must be prepared for each wavelength grid. Therefore, as compared to the prior art, according to the configuration of the embodiment of the present invention, a period of time for preparing the correction data is deleted.

Further, in a configuration disclosed in Japanese Laid-open Patent Publication No. 2011-54714, the wavelength can be controlled at arbitrary wavelength spacing by using a combination of two cyclic filters. On the other hand, in the configuration according to the embodiment of the present invention, a desired wavelength can be obtained using one etalon filter. Therefore, according to the embodiment, an optical transmitter can be provided that has a simple configuration and is applicable to a plurality of different wavelength grids.

<Hardware Configuration>

FIG. 10 illustrates an example of a hardware configuration of the optical transmitter 1. As illustrated in FIG. 10, the optical transmitter 1 includes an LD module 60 and a CPU 70. The LD module 60 includes the light source 11, the optical splitters 13 and 14, the etalon filter 15, the photo detectors 21 and 23, the temperature adjustment devices (TEC) 31 and 41, and the temperature monitors 32 and 42. The CPU 70 executes a given program, and thereby provides functions of the difference calculator 25, the switches 33 and 43, the TEC controllers 34 and 44, and the sequence controller 51. A signal transmitted from the LD module 60 to the CPU 70 is converted to a digital signal by an analog-to-digital converter (ADC). A signal transmitted from the CPU 70 to the LD module 60 is converted to an analog signal by a digital-to-analog converter (DAC).

The optical transmitter 1 may include other functions not illustrated in FIG. 10. For example, the optical transmitter 1 may include an interface for receiving instructions from a user or application. In this case, the target wavelength is given to the CPU 70 via this interface.

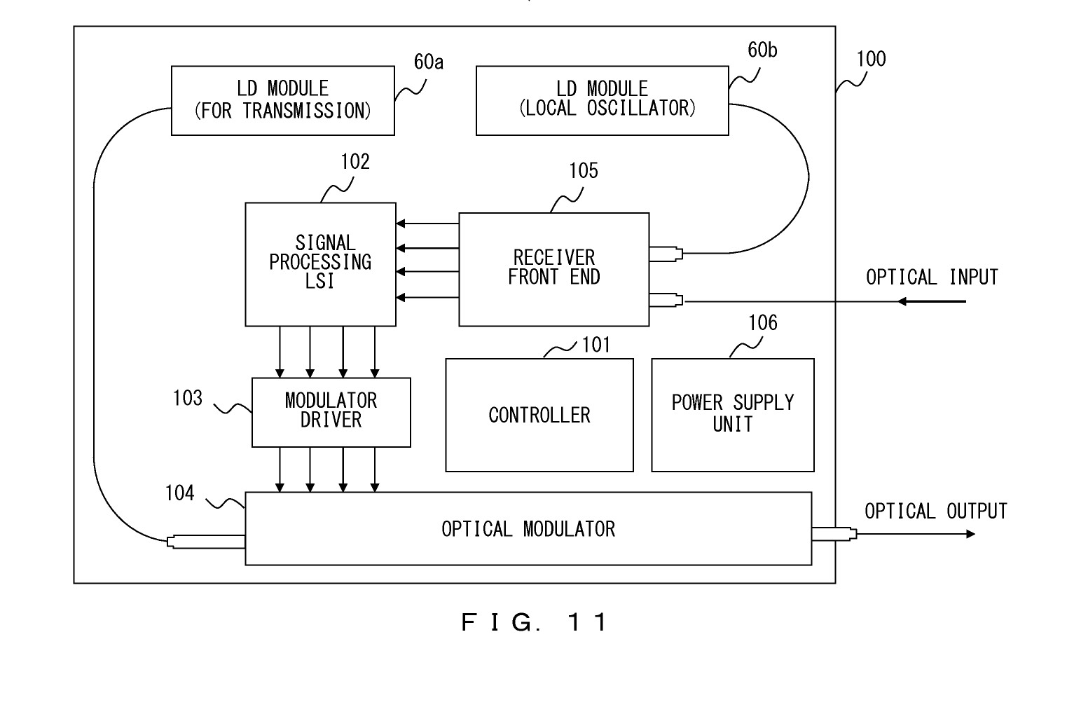

FIG. 11 illustrates an example of an optical transceiver module including the optical transmitter. The optical transceiver module 100 includes LD modules 60a and 60b, a controller 101, a signal processing LSI 102, a modulator driver 103, an optical modulator 104, a receiver front-end circuit 105, and a power supply unit 106. The LD modules 60a and 60b are realized by the LD module 60 illustrated in FIG. 10, respectively. Note that the LD module 60a generates carrier light of an optical signal transmitted from the optical transceiver module 100. The LD module 60b generates local oscillation light for performing coherent reception.

The controller 101 corresponds to the CPU 70 illustrated in FIG. 10. However, the controller 101 includes the TEC driver, the analog-to-digital converter (ADC), the digital-to-analog converter (DAC) illustrated in FIG. 10, and the like. Further, the controller 101 can control wavelengths of both the LD modules 60a and 60b.

The signal processing LSI 102 generates a transmission data signal from transmission data given to the optical transceiver module 100 via a connector (not illustrated). Further, the signal processing LSI 102 recovers data from an electric field information signal generated by the receiver front end circuit 105. The modulator driver 103 generates a drive signal from the transmission data signal. The optical modulator 104 modulates output light of the LD module 60a based on the drive signal to generate a modulated optical signal. The receiver front end circuit 105 generates the electric field information signal from a received optical signal using the local oscillation light. The power supply unit 106 supplies power to each device in the optical transceiver module 100.

### Other Embodiments

The optical transmitter 1 (or the optical transceiver module 100) may be implemented, for example, in a WDM transmission equipment. In this case, the WDM transmission equipment includes a plurality of the optical transmitters 1. The LD module 60 of each of the optical transmitters 1 is controlled so as to generate light of the wavelength corresponding to each of the specified channels.

Meanwhile, in the WDM transmission system, adding or switching of a path may be performed during operation. In this case, in the WDM transmission equipment, the wavelength of the output light of the optical transmitter according to the adding or switching of the path is adjusted. On the other hand, optical signals of other channels are continuously transmitted. Therefore, there is a possibility that when the wavelength of the output light of a certain channel is adjusted, an influence will be exerted on adjacent channels.

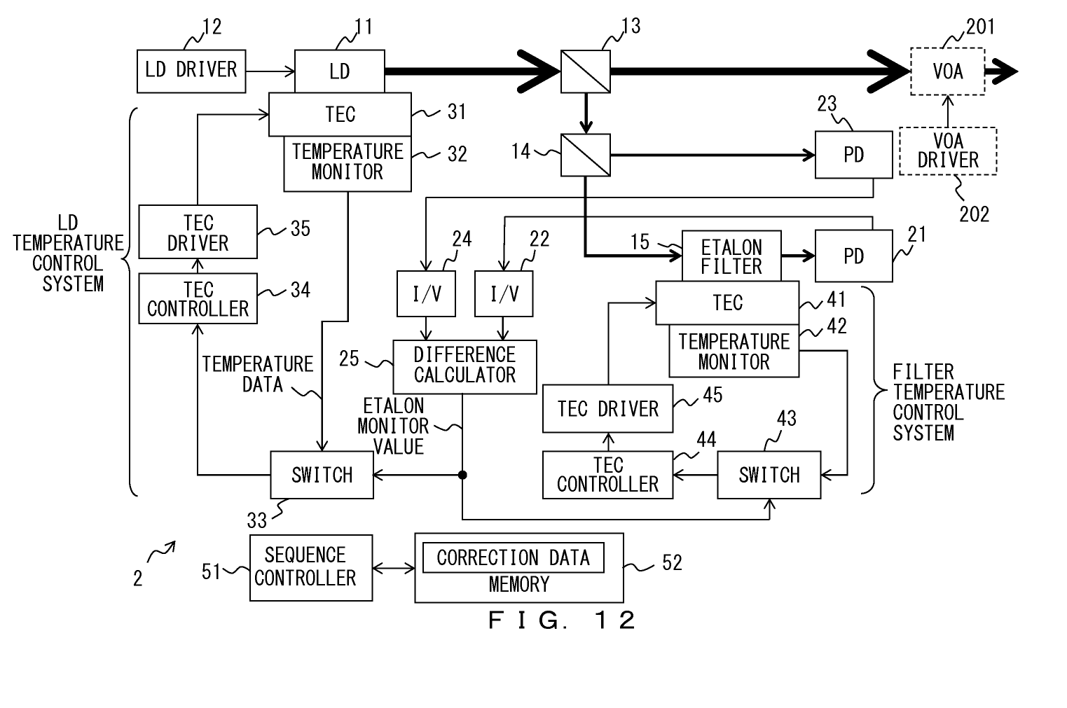

FIG. 12 illustrates an example of an optical transmitter according to another embodiment of the present invention. In addition to the optical transmitter 1 illustrated in FIG. 1, the optical transmitter 2 illustrated in FIG. 11 has a variable optical attenuator (VOA) 201 and a VOA driver 202.

The variable optical attenuator 201 attenuates the output light of the light source 11 under the control of the VOA driver 202. The VOA driver 202 controls the variable optical attenuator 201 according to the instruction from the sequence controller 51. When the wavelength of the output light of the light source 11 is adjusted, the sequence controller 51 controls an attenuation factor of the variable optical attenuator 201 so that the output light of the light source 11 is substantially cut off.

Note that the optical transmitter 2 may be configured to have another optical device in place of the variable optical attenuator 201. For example, the variable optical attenuator 201 may be replaced with a liquid-crystal shutter. Further, in a configuration in which the optical transmitter 2 includes an optical amplifier that amplifies the output light of the light source 11, a gain of the optical amplifier is controlled, and thereby the same function as that of the variable optical attenuator 201 may be realized.

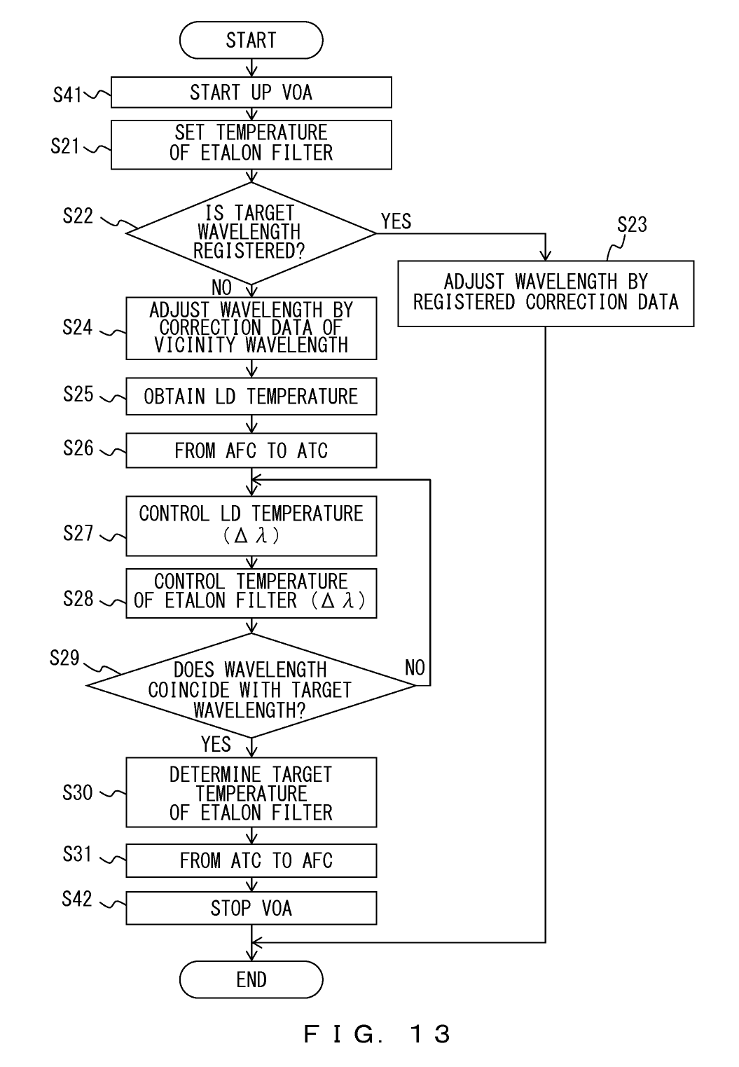

FIG. 13 is a flowchart illustrating a method for adjusting the wavelength in the optical transmitter 2 illustrated in FIG. 12. FIG. 7 is substantially the same as FIG. 13 in processes of S21 to S31, and therefore descriptions will be omitted.

In S41, before the processes of S21-S31 are performed, the sequence controller 51 controls the attenuation factor of the variable optical attenuator 201 so that the output light of the light source 11 is substantially cut off. Further, in S42, when the processes of S21-S31 are completed, the sequence controller 51 minimizes the attenuation factor of the variable optical attenuator 201. As described above, in the optical transmitter 2 illustrated in FIG. 12, the output light of the light source 11 is substantially cut-off while the wavelength of the output light of the light source 11 is adjusted. Accordingly, even if the WDM transmission system is being operated, the wavelength of the output light of the optical transmitter can be adjusted to a desired wavelength without exerting an influence on other channels.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical transmitter comprising:
a wavelength tunable light source;
an etalon filter that filters output light of the wavelength tunable light source;
a measurement unit that generates a monitor value corresponding to power of output light of the etalon filter; and
a controller that controls a temperature of the wavelength tunable light source to adjust a wavelength of the output light of the wavelength tunable light source, and controls a temperature of the etalon filter to adjust transmission characteristics of the etalon filter, wherein
the controller controls the temperature of the wavelength tunable light source to adjust the wavelength of the output light of the wavelength tunable light source to a specified wavelength, and
during the wavelength of the output light of the wavelength tunable light source is adjusted from the specified wavelength to a target wavelength, the controller alternately performs first processing to control the temperature of the wavelength tunable light source based on the monitor value so as to shift the wavelength of the output light of the wavelength tunable light source by a specified amount, and second processing to control the temperature of the etalon filter based on the monitor value so as to shift the transmission characteristics of the etalon filter by the specified amount.

2. The optical transmitter according to claim 1, wherein
the controller controls the temperature of the wavelength tunable light source so that the monitor value changes by a value corresponding to the specified amount in the first processing.

3. The optical transmitter according to claim 2, wherein
the controller controls the temperature of the etalon filter so that the monitor value changes by a value corresponding to the specified amount in the second processing.

4. The optical transmitter according to claim 1, further comprising
a memory that stores correction data representing the temperature of the wavelength tunable light source and the monitor value for generating light of each wavelength on a specified wavelength grid, wherein
the specified wavelength is one of the wavelengths on the specified wavelength grid, and
the controller obtains from the memory the correction data representing the temperature and the monitor value corresponding to the specified wavelength, and adjusts the wavelength of the output light of the wavelength tunable light source to the specified wavelength using the obtained correction data.

5. The optical transmitter according to claim 4, wherein
wavelength characteristic data representing a tilt of the monitor value with respect to a wavelength and temperature characteristic data representing a tilt of the monitor value with respect to a temperature are further stored in the memory, and
the controller changes the temperature of the wavelength tunable light source based on the wavelength characteristic data so that the monitor value changes by a value corresponding to the specified amount in the first processing, and changes the temperature of the etalon filter based on the temperature characteristic data so that the monitor value changes by a value corresponding to the specified amount in the second processing.

6. The optical transmitter according to claim 1, further comprising:
an optical splitter that branches the output light of the wavelength tunable light source and guides the branched output light to an output port and the etalon filter; and
a power controller that controls power of the output light of the wavelength tunable light source guided from the optical splitter to the output port, wherein
the controller controls the power controller to attenuate the power of the output light of the wavelength tunable light source during a time period in which the first processing and the second processing are alternately performed.
